(19) United States
(12) Patent Application Publication
(10) Pub. No.: US 2026/0077542 A1
(43) Pub. Date: Mar. 19, 2026

(54) PRINTING APPARATUS, METHOD FOR CONTROLLING PRINTING APPARATUS, AND STORAGE MEDIUM

(71) Applicant: CANON KABUSHIKI KAISHA, Tokyo (JP)

(72) Inventors: Tomokazu Ishikawa, Kanagawa (JP); Yuta Ikeshima, Kanagawa (JP); Takahisa Akaishi, Kanagawa (JP)

(21) Appl. No.: 19/328,312

(22) Filed: Sep. 15, 2025

(30) Foreign Application Priority Data
Sep. 19, 2024 (JP) 2024-162507

(51) Int. Cl. B29C 44/02; B29C 44/04; B29C 44/12; B29C 44/34; B29C 44/60

(52) U.S. Cl. CPC B29C 44/022; B29C 44/04; B29C 44/1271; B29C 44/3415; B29C 44/605

(57) ABSTRACT

An embodiment of the present disclosure has a printhead configured to print an image for characteristic detection onto a printing medium containing foaming particles by ejecting a foaming promotion liquid and a colored liquid, the image for characteristic detection having at least N unit regions, the colored liquid being applied to the at least N unit regions in equal amounts, and the foaming promotion liquid being applied to the at least N unit regions in amounts varying in stages; a foaming unit configured to foam the foaming particles; a scan unit configured to scan the image for characteristic detection and obtain, as scan results of the image for characteristic detection, correspondences between the at least N unit regions and scan values of the colored liquid; and a calculation unit configured to calculate a correction value for correcting an application amount of the foaming promotion liquid based on the scan results.

### BACKGROUND

### Field of the Technology

The present disclosure relates to a printing apparatus, a method for controlling the printing apparatus, and a program and particularly to a technique for printing a three-dimensional image having a textured structure onto a printing medium.

### Description of the Related Art

What is conventionally known as a printing apparatus that prints a three-dimensional image is one that forms a textured structure on the surface of a foaming sheet by applying a foaming promotion liquid and applying heat, electromagnetic waves, or the like thereto.

Japanese Patent Laid-Open No. 2018-86809 describes forming a textured structure by applying a foaming promotion liquid for promoting foaming to the surface of a foaming sheet and then applying electromagnetic waves thereto. In order for the textured structure to have a desired height, the amount of the foaming promotion liquid applied in forming the textured structure is adjusted according to the type of a pattern image.

In view of the fact that it is not easy for a scanner or a sensor such as a colorimeter to detect a colorless, transparent liquid applied to a printing medium, Japanese Patent Laid-Open No. 2005-35042 describes a configuration of applying both a colorless, transparent liquid and a colored liquid to a printing medium so that the colorless, transparent liquid can be scanned by a sensor.

However, in an inkjet printhead where print elements are arranged in the width direction of a printing medium, ink ejection characteristic may differ for every print element that prints. In such a case where the print elements apply different amounts of foaming promotion liquid to a forming layer, the amount of foaming particles that foam varies, leading to a problem where the texture height after the foaming does not achieve a desired height.

Also, even though a colorless, transparent liquid and a colored liquid are applied to a printing medium, the ejection characteristic of print elements for the colorless, transparent liquid and that for the colored liquid cannot be isolated from each other, leading to a problem where it is difficult to detect the ejection characteristic of print elements for the colorless, transparent liquid.

### SUMMARY

Thus, in view of the above problems, the present disclosure aims to provide a technique for detecting the ejection characteristic of print elements for the foaming promotion liquid.

An embodiment of the present disclosure is a printing apparatus including: a printhead configured to print an image for characteristic detection onto a printing medium containing foaming particles by ejecting a foaming promotion liquid and a colored liquid to the printing medium, the image for characteristic detection having at least N unit regions (where N is three or greater), the colored liquid being applied to the at least N unit regions in equal amounts, and the foaming promotion liquid being applied to the at least N unit regions in amounts varying in stages; a foaming unit configured to foam the foaming particles contained in the printing medium after the image for characteristic detection is printed by the printhead; a scan unit configured to scan the image for characteristic detection after the foaming particles are foamed by the foaming unit, the scan unit obtaining, as scan results of the image for characteristic detection, correspondences between the at least N unit regions and scan values of the colored liquid in the respective at least N unit regions, the correspondences including a region where a scan value obtained by the scan unit increases and a region where a scan value obtained by the scan unit decreases; and a calculation unit configured to calculate a correction value for correcting an application amount of the foaming promotion liquid based on the scan results, the calculation unit including calculating the correction value based on a first density value corresponding to a first unit region of the at least N unit regions which is where the scan unit obtains a lowest scan value.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view illustrating a printing medium in a first embodiment.

FIG. 2 is a diagram showing a schematic configuration of a printing apparatus of the first embodiment.

FIG. 3 is a diagram illustrating the configuration of a printhead in the first embodiment;

FIGS. 4A and 4B are diagrams showing an image submittable to the printing apparatus in the first embodiment.

FIG. 5 is a block diagram showing the configuration of a system in the first embodiment.

FIG. 6 is a diagram of a sequence followed to offer a print service in the first embodiment.

FIG. 7 is a flowchart of processing performed in printing an image in the first embodiment.

FIG. 8 is a flowchart of processing for calculating a correction value for the application amount of a foaming promotion liquid in the first embodiment.

FIG. 9 is a diagram showing scan results for an image for characteristic detection in the first embodiment.

FIGS. 10A and 10B are diagrams showing an image for characteristic detection in the first embodiment.

FIGS. 11A and 11B are diagrams showing an image for characteristic detection in a second embodiment.

### DESCRIPTION OF THE EMBODIMENTS

Preferred embodiments of the present disclosure are described below with reference to the drawings.

### First Embodiment

### <Printing Medium>

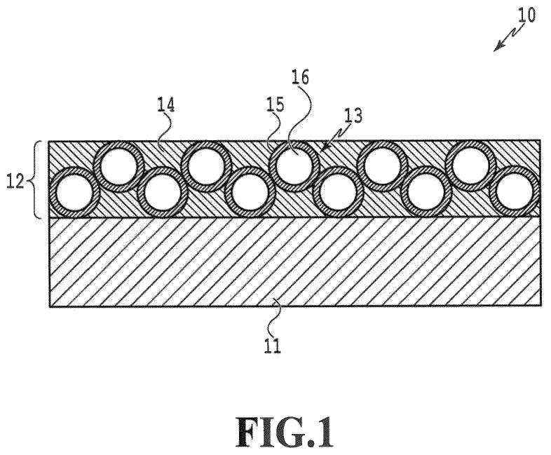

In the present embodiment, a three-dimensional image having a projecting structure is printed on a printing medium. FIG. 1 is a sectional view schematically showing a printing medium used for printing of a three-dimensional image in the present embodiment. A printing medium 10 has a base material 11 and a foaming layer 12 provided on the base material. The foaming layer 12 contains foaming particles 13 that foam under heat.

The base material 11 functions as a support for supporting the foaming layer 12. There is no limitation on the type of the base material. The base material 11 may be, e.g., regular paper made from natural pulp, kenaf paper, a plastic film sheet, what is called synthetic paper, which is synthetic pulp or synthetic resin film made to imitate paper, or nonwoven fabric. Note that examples of the plastic film sheet here include a plastic film sheet made of polypropylene, polyethylene, polyester, or the like.

The foaming layer 12 is provided on at least one of the surfaces of the base material 11 and contains the foaming particles 13 and binder resin 14. The foaming particles 13 are each a thermally expandable microcapsule having a capsular shell layer 15 containing thermoplastic resin and a volatile material 16 sealed inside the shell layer 15. Applying heat to the foaming particle 13 softens the thermoplastic resin forming the shell layer 15. At the same time, the volatile material 16 sealed inside the shell layer 15 gasifies, causing the foaming particle 13 to increase in volume and expand like a balloon.

Examples of the thermoplastic resin contained in the shell layer 15 include polystyrene, styrene-acrylate ester copolymers, polyamide rein, polyacrylate ester, polyvinylidene chloride, polyacrylonitrile, and polymethylmethacrylate. Other examples include vinylidene chloride-acrylonitrile, methacrylate ester-acrylate copolymer, vinylidene chloride-acrylate copolymer, and vinylidene chloride-acrylate ester copolymer.

Examples of the volatile material 16 include low-molecular-weight hydrocarbon such as ethane, ethylene, propane, propene, n-butane, isobutane, n-pentane, isopentane, neopentane, n-hexane, heptane, and petroleum ether. Other examples include chlorofluorocarbon such as CC13F, CC12F2, CC1F3, and CC1F2-CC1F2. Other examples include tetraalkylsilane such as tetramethylsilane, trimethylethylsilane, trimethylisopropylsilane, and trimethyl-n-propylsilane. The volatile material is preferably hydrocarbon with a molecular weight of 120 or below. For example, the lower limit of the molecular weight of the volatile material (hydrocarbon) is preferably, but not limited to, 50 or greater. The amount of foaming particles 13 contained in the foaming layer is preferably 5% or higher by mass and 95% or lower by mass in relation to the total mass of the foaming layer.

The foaming layer 12 contains the binder resin 14 to enhance adhesiveness to the base material 11. The binder resin 14 plays an important role in helping prevent the foaming layer 12 from peeling off from the base material 11 in the event where the foaming particles 13 foam under heat. Water-insoluble resin is used as the binder resin 14. Being difficult to be dissolved by the water in a foaming promotion liquid, the water-insoluble resin can keep adhesiveness between the foaming layer 12 and the base material 11 even after the application of the foaming promotion liquid. Also, for a similar reason, the water-insoluble resin can keep adhesiveness between the foaming layer 12 and the base material 11 even after a water-based ink containing water is applied onto the printing medium.

The water-insoluble resin refers to resin that retains 95% or more of its mass after immersion in warm water at 80° C. for two hours. The water-insoluble resin is preferably at least one selected from a group consisting of acrylic resins and urethane resins. The water-insoluble resin is more preferably at least one selected from a group consisting of acrylic resins without ester groups and urethane resins without ester groups, and is even more preferably non-hygroscopic resin. The amount of water-insoluble resin contained in the foaming layer 12 is preferably 10% or higher by mass and 95% or lower by mass in relation to the total mass of the foaming layer. Also, the foaming layer 12 may contain water-soluble resin along with the water-insoluble resin as long as the advantageous effects of the present embodiment can be achieved.

The glass transition temperature of the binder resin 14 is preferably −10° C. or higher and 30° C. or lower. By having a glass transition temperature within this range, the binder resin 14 can avoid hindering the foaming of the foaming particles 13.

The mass ratio of the foaming particles 13 to the binder resin 14 is preferably such that the foaming particles 13:the binder resin 14=5:95 to 90:10. The mass ratio of the foaming particles 13 to the binder resin 14 being within this range can improve both of the foamability of the foaming particles 13 and adhesion to the base material 11 provided by the binder resin 14. The foaming layer 12 may further contain a component such as a pigment, an antioxidant, a dye, or a surfactant as long as the component does not compromise foamability.

### <Foaming Promotion Liquid>

A foaming promotion liquid that promotes foaming is an example of a foaming control liquid for controlling the extent of foaming of the foaming particles. The present embodiment uses a foaming promotion liquid containing a foaming promotion component that lowers the temperature at which the foaming particles 13 start foaming. As a result of applying the foaming promotion liquid to the foaming layer 12 of the printing medium 10 by use of a method such as ejection by the inkjet method or application using a roller, the thermoplastic resin in the shell layer 15 softens. As a result, it is estimated that the temperature at which the foaming particles 13 start foaming can be shifted to the lower temperature side.

The foaming promotion component is a component which can soften the thermoplastic resin contained in the shell layer 15. The foaming promotion component is a compound without hydroxyl groups and is appropriately selected for use depending on the type of the thermoplastic resin or the like. Examples of the foaming promotion component include 2-pyrrolidone, dimethylsulfoxide, N,N-dimethylformamide, and N-methyl-2-pyrrolidone. The boiling point of the compound without hydroxyl groups as the foaming promotion component is preferably higher than the temperature for heating the foaming layer 12. In a case where the boiling point of the foaming promotion component is higher than the temperature for heating the foaming layer 12, heating of the foaming layer does not gasify the foaming promotion component, but contributes to softening of the thermoplastic resin in the shell layer 15. The amount of this foaming promotion component contained in the foaming promotion liquid is preferably 10% or higher by mass and 70% or lower by mass in relation to the total mass of the foaming promotion liquid.

It is preferable that the absolute value (|SP1−SP2|) of the difference between a solubility parameter (SP1) of the thermoplastic resin in the shell layer 15 and a solubility parameter (SP2) of the foaming promotion component be 3.5 or below. The absolute value of the difference of these solubility parameters being within this range makes it possible to improve the foamability of the region where the foaming promotion liquid has been applied.

Also, the absolute value (|HSP1−HSP2|) of the difference between the Hansen solubility parameter (HSP1) of the thermoplastic resin in the shell layer 15 and a Hansen solubility parameter (HSP2) of the foaming promotion component be 20 or below. The absolute value of the difference between these Hansen solubility parameters being within this range makes it possible to improve the foamability of the region where the foaming promotion liquid has been applied.

The solubility parameters (SP values) of the thermoplastic resin in the shell layer 15 and the foaming promotion component are both calculable values. Also, the Hansen solubility parameters (HSP values) of the thermoplastic resin in the shell layer 15 and the foaming promotion component are both actual measured values measurable and calculable using dynamic light scattering.

Note that in a case where the foaming promotion component is liquid at ordinary temperatures, the foaming promotion component itself may be used as the foaming promotion liquid. Also, the foaming promotion liquid may further contain a component in addition to the foaming promotion component. For example, the foaming promotion liquid may further contain a liquid component such as a solvent for improving the ejection stability of the foaming promotion liquid. Any of various water-based and water-soluble organic solvents can be used as the solvent. Deionized water (ion-exchanged water) is preferably used as the water. Examples of the water-soluble organic solvent include alcohols, glycols, glycol ethers, and nitrogen-containing compounds.

As a non-liquid component, a water-soluble organic compound which is solid at a temperature of 25° C. is used, such as urea and its derivatives, trimethylolpropane, and trimethylolethane. The foaming promotion liquid may further contain various additives as needed, such as a pH adjuster, an antifoaming agent, an antirust agent, an antiseptic agent, an antifungal agent, an antioxidant, a reduction inhibitor, and a chelator.

<Printing Apparatus that Prints a Three-Dimensional Image by Forming a Textured Structure>

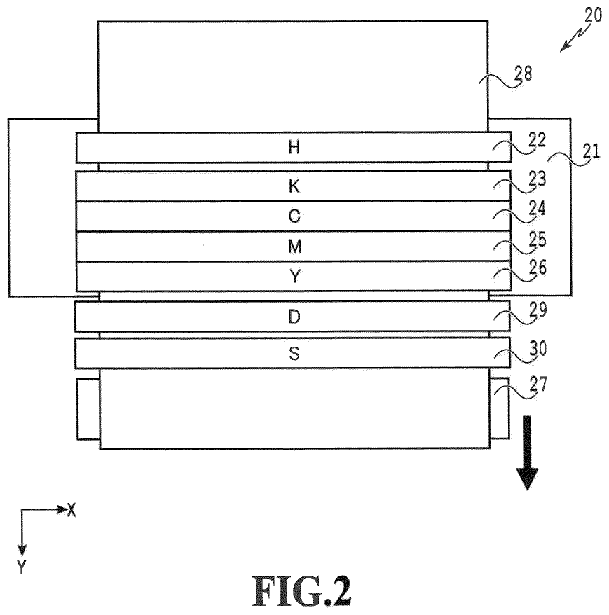

FIG. 2 is a schematic configuration diagram of a printing apparatus 20 of the present embodiment. The printing apparatus 20 is a full-line inkjet printing apparatus. A printhead 21 having a width equivalent to that of the printing medium 10 and a heater device 29 having a heating unit are disposed at positions different from each other in the Y-direction. The printhead 21 includes a print element array 22 which is an array of a plurality of print elements configured to eject droplets of the foaming promotion liquid (H). Similarly, the printhead 21 includes a print element array 23 configured to eject liquid droplets of a K ink, which is a colored liquid containing a colorant, a print element array 24 configured to eject liquid droplets of a C ink, a print element array 25 configured to eject liquid droplets of an Mink, and a print element array 26 configured to eject liquid droplets of a Y ink. Note that black, cyan, magenta, and yellow are denoted herein as K, C, M, and Y, respectively.

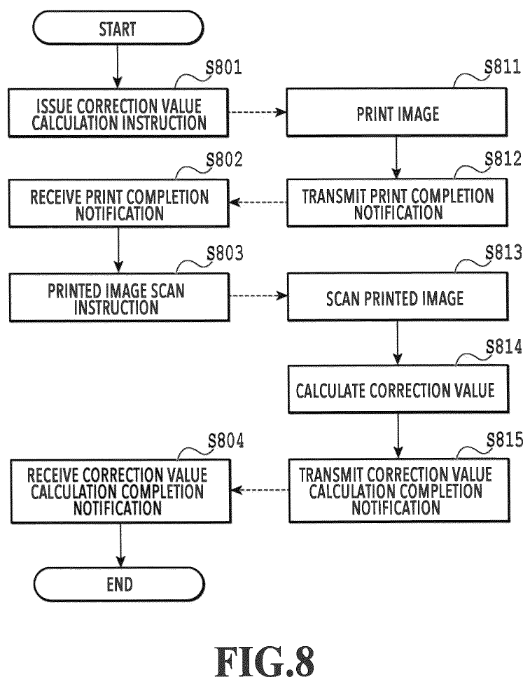

The print element arrays 22 to 26 are disposed at positions different from one another in a conveyance direction in which a printing medium is conveyed (the Y-direction in the drawings). The Y-direction position of the print element array 22 for the foaming promotion liquid may be upstream (a −Y-direction) or downstream (a +Y-direction) of the print element arrays 23 to 26 configured to eject colored liquids. The foaming promotion liquid ejected from the print element array 22 is applied to the foaming layer 12 which is in an upper part of the printing medium 10. The heater device 29 is disposed downstream of the print element arrays 22 to 26 in the conveyance direction. The heater device 29 may employ any heating method as long as it can heat the foaming particles 13 in the foaming layer 12 to a desired temperature. Examples include a dryer, an oven, a heater, and an iron. A scanner 30 is provided at a position downstream of the heater device 29 in the conveyance direction. In the scanner 30, scan elements are arrayed in the X-direction at a predetermined pitch and used for image scanning, such as scanning of an image printed on a printing medium in calculation of a correction value for the application amount of the foaming promotion liquid, which will be described later using FIG. 8. Then, as a scan result of the scanner 30, RGB data in a color space of color measurement values is outputted. RGB data has 8-bit information for each color with the value ranging from 0 to 255; however, RGB data may be formed of a different number of bits, such as 16 bits. Note that red, green, and blue are denoted herein as R, G, and B, respectively.

An application operation of applying the foaming promotion liquid and the colored liquids to the printing medium 10 is also referred to as a printing process. After the foaming promotion liquid containing the foaming promotion component is applied to the printing medium 10 having the foaming layer 12, the foaming layer 12 of the printing medium 10 is heated. By being heated, the foaming particles 13 in a region where the foaming promotion liquid has been applied expand and foam, printing a three-dimensional image expressing a vivid projecting structure on the printing medium 10. As a conveyance roller 27 rotates, the printing medium 10 is conveyed in the conveyance direction at a predetermined speed, and the printing process by the printhead 21 and the heating process by the heater device 29 are performed. A printing operation by the printhead 21 and a conveyance operation by a conveyance unit (such as the conveyance roller 27) are performed alternately. At the positions where the printing process and the heating process are performed, the printing medium 10 is supported from below by a platen 28 formed of a flat plate. This fixes the distance from the printhead 21 or the heater device 29 to the printing medium 10 and maintains smoothness.

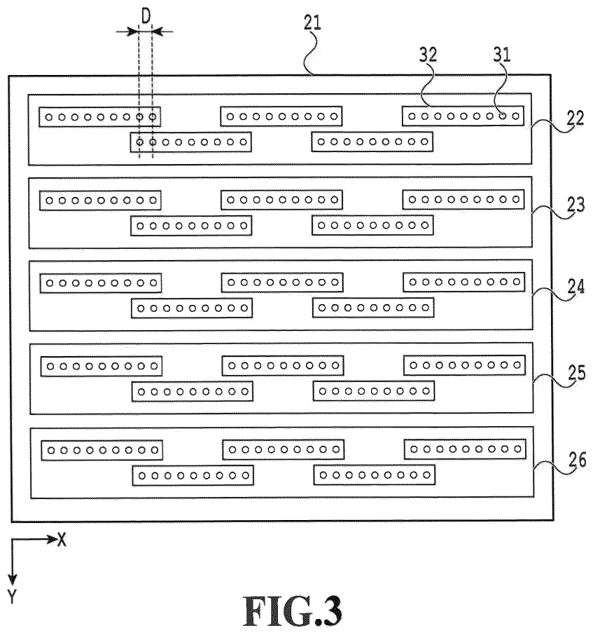

FIG. 3 is a plan view showing a schematic configuration of the printhead 21. In the printhead 21, the print element arrays 22 to 26 are each formed of a plurality of print element substrates 32. The print element substrates 32 are arranged alternately in the Y-direction, extending continuously in the X-direction with every adjacent ones of them being provided with an overlap region D. Each print element substrate 32 has a plurality of print elements 31 arrayed at a certain pitch. According to print data, ink droplets are ejected from the print elements 31 at a certain frequency to the printing medium 10 conveyed in the +Y-direction at a certain speed, thereby printing an image on the printing medium 10 at a resolution corresponding to the interval at which the print elements 31 are arrayed.

### <Submitted Image>

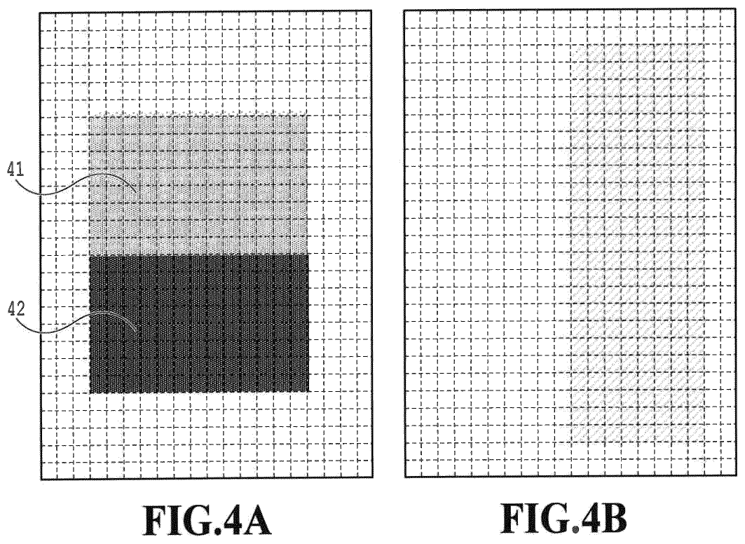

FIGS. 4A and 4B are showing an example image submittable to the printing apparatus 20 of the present embodiment. A submitted image is formed of a colored version for applying a colored liquid and a foaming version for applying the foaming promotion liquid. In FIGS. 4A and 4B, the minimum-unit squares sectioned by broken lines each represent one pixel.

FIG. 4A is an example of the foaming version. In the foaming version, the shade of gray indicates a region on the printing medium 10 to be foamed and expanded and the extent of the expansion. The foaming version of the present embodiment is grayscale data having 8-bit information for each color with the value ranging from 0 to 255, but the number of bits is not limited to 8 bits and may be any value such as 16 bits. In the foaming version, a high density region represents a portion to be expanded on the printing medium 10. The higher the density (the lower the brightness) of a pixel, the larger the extent of expansion, and the lower the density (the higher the brightness), the smaller the extent of expansion. A region 41 has a density of M, a region 42 has a density of N, and M<N. The region 42 has a higher density and a larger extent of expansion. The larger the extent of expansion, the higher the projecting structure, and the smaller the extent of expansion, the lower the height of the projecting structure.

In this way, a pattern with shades of gray is drawn on the foaming version with a region to be expanded more being higher in density. According to the value of each pixel, a three-dimensional structure of a desired height can be formed on the printing medium 10.

FIG. 4B is an example of the colored version. In the colored version, the shade of gray indicates a hue for coloring the printing medium 10. The colored version of the present embodiment is RGB data, and examples of its type include standard color information such as sRGB or Adobe (registered trademark) RGB. The image data in the present embodiment has 8-bit information for each color with the value ranging from 0 to 255, but the number of bits is not limited to 8 bits and may be any value such as 16 bits. In a case of creating a submitted image in a format such as PDF, the foaming version in FIG. 4A and the colored version in FIG. 4B need to be created as different layers.

### <System Configuration>

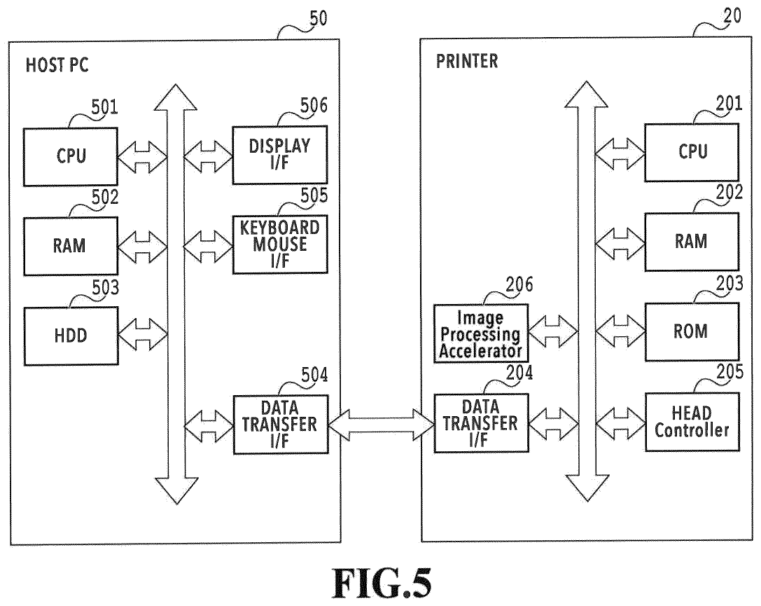

FIG. 5 is a block diagram showing an overall configuration of a system of the present embodiment. The system of the present embodiment includes the printing apparatus 20 shown in FIG. 2 and a personal computer (PC) 50 functioning as a host apparatus for the printing apparatus 20.

The PC 50 includes a central processing unit (CPU) 501, random-access memory (RAM) 502, and a hard disk drive (HDD) 503. The PC 50 further includes a communication I/F 504, an input device I/F 505, and a display device I/F 506, and these components are communicatively connected to one another by an internal bus. Note that an interface is abbreviated herein as I/F.

The CPU 501 executes processing according to programs and various kinds of data stored in the HDD 503 or the RAM 502. The RAM 502 is a volatile storage and stores programs and data temporarily. The HDD 503 is a non-volatile storage and stores programs and data persistently.

The communication I/F 504 is an interface that governs communications with an external device for the PC 50 and controls data transmission and reception to and from the printing apparatus 20 here. Examples of a connection method used for the data transmission and reception include wired connection such as Universal Serial Bus (USB), IEEE1394, or a local area network (LAN) and wireless connection such as Bluetooth (registered trademark) or WiFi (registered trademark).

The input device I/F 505 is an interface for controlling a human interface device (HID) such as a keyboard or a mouse and receives an input from an input device.

The display device I/F 506 controls display on a display device such as a display (not shown).

The printing apparatus 20 includes a CPU 201, RAM 202, read-only memory (ROM) 203, a communication I/F 204, a head controller 205, and an image processing accelerator 206, and the components are communicatively connected to one another by an internal bus.

The CPU 201 executes processing to be described later according to programs and various kinds of data stored in the ROM 203 or the RAM 202. The RAM 202 is a volatile storage and stores programs and data temporarily. The ROM 203 is a non-volatile storage and stores programs or data in a plurality of lookup tables used in processing to be described later.

The communication I/F 204 is an interface that governs communications with an external device for the printing apparatus 20 and controls data transmission and reception to and from the PC 50 here. The head controller 205 controls a printing operation by the printhead 21 shown in FIG. 2 based on print data. Specifically, the head controller 205 is a configuration for reading, from a predetermined address in the RAM 202, control parameters and print data for the printhead to print. Once the CPU 201 writes control parameters and print data to a predetermined address in the RAM 202, the head controller 205 activates processing, causing the print elements 31 of the printhead 21 to eject the foaming promotion liquid and the colored liquids. The image processing accelerator 206 is configured by hardware and executes image processing at a higher speed than the CPU 201. Specifically, the image processing accelerator 206 reads, from a predetermined address in the RAM 202, parameters and data necessary for the image processing. Then, once the CPU 201 writes the parameters and data described above to a predetermined address in the RAM 202, the image processing accelerator 206 is activated and performs predetermined image processing. Note that the image processing accelerator 206 is not necessarily an essential element, and depending on the specifications of the printing apparatus 20, it may be the CPU 201 that executes image processing and processing to create parameters to be held in the lookup tables.

Although the printing apparatus 20 and the PC 50 are separate apparatuses in the present embodiment described above, it is to be noted that the system may have them integrated. Also, although a PC is used as an example of the host apparatus, the host apparatus is not limited to a PC and may be a mobile terminal such as a smartphone, a tablet terminal, or an image capture device.

### <Sequence Followed to Offer a Print Service>

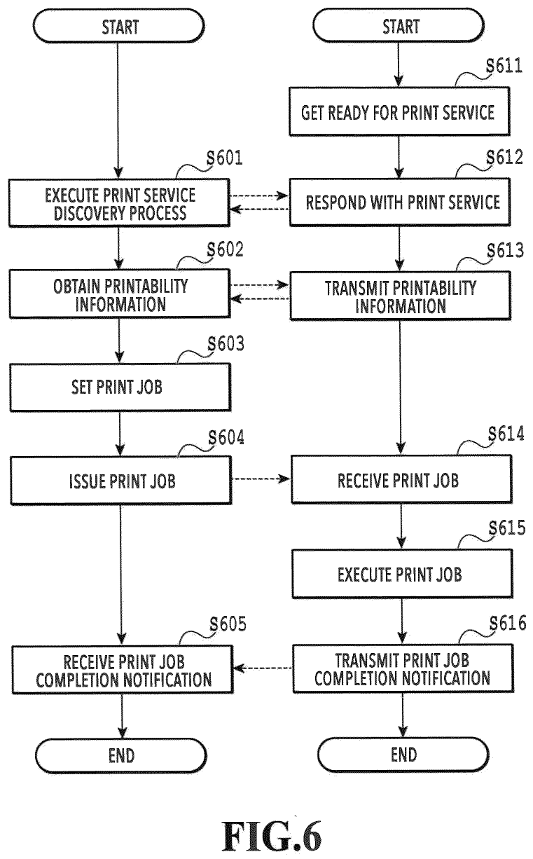

FIG. 6 is a diagram showing a sequence followed to offer a print service in the present embodiment. Processing in each of Steps S601 to S605 is executed by the PC 50, and processing in each of Steps S611 to S616 is executed by the printing apparatus 20. Note that “Step SXXX” will be abbreviated as “SXXX” hereinbelow.

The broken-line arrows in FIG. 6 denote data transmission and reception. Processing in each of S601 to S605 is implemented by the CPU 501 of the PC 50 (see FIG. 5) by reading and executing programs and the like stored in the storage unit of the PC 50. Processing in each of S611 to S616 is implemented by the CPU 201 of the printing apparatus 20 (see FIG. 5) by reading and executing programs and the like stored in the storage unit of the printing apparatus 20. Note that the processing in FIG. 6 is started in response to the printing apparatus 20 being powered on.

After the printing apparatus 20 is powered on, in S611 the CPU 201 checks whether the printing apparatus 20 is able to print and goes into a standby state where a print service can be provided.

In S601, the CPU 501 executes a print service discovery process. By this step, a print service discovery request is transmitted to the printing apparatus 20. Note that as the print service discovery process, a search may be done for peripherals according to a user operation, or a search may be done periodically for a printing apparatus capable of providing a print service. Alternatively, the CPU 501 of the PC 50 may make an inquire once a connection is established between the PC 50 and the printing apparatus 20.

Once the printing apparatus 20 receives the print service discovery request transmitted from the PC 50, in S612 the CPU 201 transmits a notification to the PC 50 as a response to the request thus received, the notification informing that the printing apparatus 20 can provide a print service.

Once the PC 50 receives the notification transmitted thereto from the printing apparatus 20 informing that the printing apparatus 20 can provide a print service, in S602 the CPU 501 transmits a request to the printing apparatus 20 for information on the print service that can be provided by the printing apparatus 20 (this information is called printability information).

Once the printing apparatus 20 receives the request for the printability information transmitted from the PC 50, in S613 the CPU 201 transmits the printability information to the PC 50 as a response to the received request.

Once the PC 50 receives the printability information transmitted from the printing apparatus 20, in S603 the CPU 501 creates a user interface for creating a print job based on the received printability information and presents the user interface to the user. Specifically, the CPU 501 creates a graphical user interface (GUI) screen built based on the printability information and including a means for specifying an image to be printed, print size options, print sheet size options, and the like, and displays the created GUI screen on the display. Then, seeing this GUI screen, the user enters print job settings information using the input device, and the CPU 501 receives the print job settings information thus entered.

In S604, the CPU 501 creates a print job based on the print job settings information received in S603 and issues, i.e., transmits, the created print job to the printing apparatus 20.

In S614, the CPU 201 receives the print job transmitted from the PC 50 in S604.

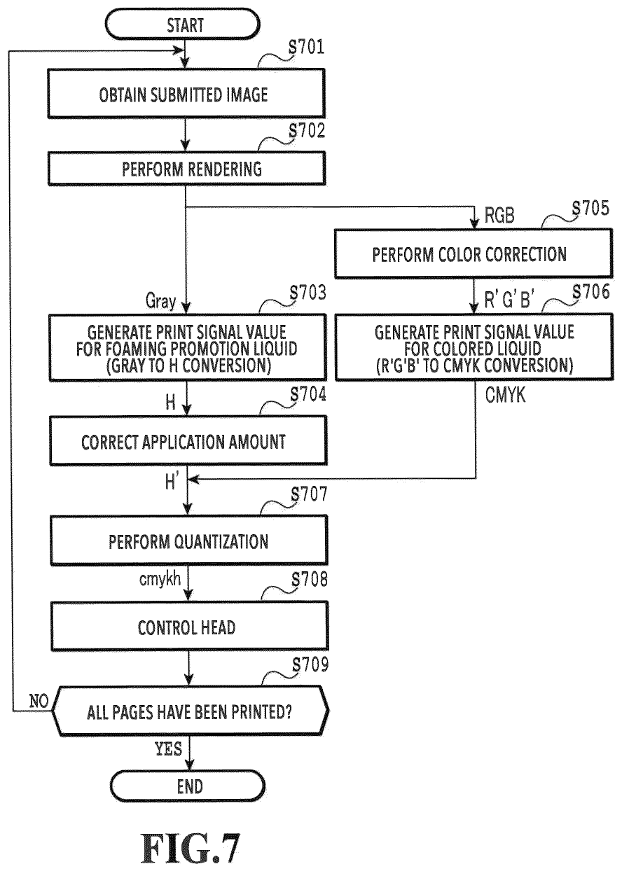

In S615, the CPU 201 analyzes the print job received in S614 and executes a printing process based on the result of the analysis. Note that details of the printing process executed in this step will be described later (see FIG. 7).

Once the printing process executed in S615 is completed, in S616 the CPU 201 transmits a print job completion notification to the PC 50 to notify that the printing process has been completed. After the transmission of the print job completion notification, the printing apparatus 20 goes into a standby state.

In S605, the CPU 501 receives the print job completion notification transmitted from the printing apparatus 20 and notifies the user of the reception of the print job completion notification.

Note that the following the communication mode is used for various kinds of information communications described above: a request is transmitted from the PC 50 end to the printing apparatus 20, and the printing apparatus 20 responds to this request. However, the communication mode is not limited to what is called a pull type described above, and may be what is called a push type, where the printing apparatus 20 voluntarily delivers data to one or more PCs 50 existing on the network.

### <Processing for Calculating a Correction Value for the Application Amount of the Foaming Promotion Liquid>

FIG. 8 is a diagram showing a sequence followed to execute processing for calculating a correction value for the application amount of the foaming promotion liquid in the present embodiment. Processing in each of S801 to S804 is executed by the PC 50, and processing in each of S811 to S815 is executed by the printing apparatus 20. Also, the broken-line arrows in FIG. 8 denote data transmission and reception. Further, processing in each of S801 to S804 is implemented by the CPU 501 of the PC 50 (see FIG. 2) by reading and executing programs and the like from the storage unit of the PC 50. Processing in each of S811 to S815 is implemented by the CPU 201 of the printing apparatus 20 (see FIG. 2) by reading and executing programs and the like from the storage unit of the printing apparatus 20. Note that the processing in FIG. 8 starts triggered by a user operation.

In S801, the CPU 501 generates a calculation instruction to calculate the application amount of the foaming promotion liquid and issues the generated calculation instruction. The calculation instruction issued in this step is transmitted to the printing apparatus 20.

Once the printing apparatus 20 receives the instruction issued in S801, in S811 the CPU 201 executes a printing process of printing an image for calculating a correction value for the application amount of the foaming promotion liquid on the printing medium 10 based on image data for calculating a correction value for the application amount of the foaming promotion liquid stored in the ROM 203. Note that the image data used in this step is not limited to one stored in the ROM 203, and image data stored in the HDD 503 of the PC 50 may be used and transmitted to the printing apparatus 20.

In S812, the CPU 201 transmits a print completion notification to the PC 50 to notify that the printing in S811 has been completed.

Once the PC 50 receives the print completion notification transmitted in S812, in S803 the CPU 501 generates a scan instruction for the scanner 30 to scan the image printed on the printing medium 10 in S811 and issues the generated scan instruction. The scan instruction issued in this step is transmitted to the printing apparatus 20.

In S813, after the scanner 30 goes into a standby state ready to scan, the CPU 201 executes scan processing in which the scanner 30 scans the image for calculating a correction value for the application amount of the foaming promotion liquid.

In S814, the CPU 201 calculates a correction value for the application amount of the foaming promotion liquid by analyzing the image scanned by the scanner 30 in S813 and stores the calculated application amount correction value to the ROM 203. Note that the application amount correction value calculation processing in this step will be described in detail later.

In S815, the CPU 201 transmits a calculation completion notification to the PC 50 to notify that the calculation of the application amount correction value in S814 has been completed. With the completion of this step, the processing on the printing apparatus 20 end completes. After that, the printing apparatus 20 goes into a standby state.

Once the PC 50 receives the calculation completion notification transmitted in S815, in S804 the CPU 501 displays an indication on the display via the display device I/F 506 to indicate that the correction value calculation processing has ended. With completion of this step, processing on the PC 50 end completes.

Note that the above description shows a mode where the scanner 30 is used to scan the image for calculating the correction value for the application amount of the foaming promotion liquid, and the CPU 201 of the printing apparatus 20 calculates the application amount correction value. However, the following mode is also possible: image data scanned by the scanner 30 is transmitted to the PC 50, and the CPU 501 of the PC 50 calculates an application amount correction value and transmits the calculated application amount correction value to the printing apparatus 20, where the application amount correction value is stored in the ROM 203.

### <Correction Value for the Application Amount of the Foaming Promotion Liquid>

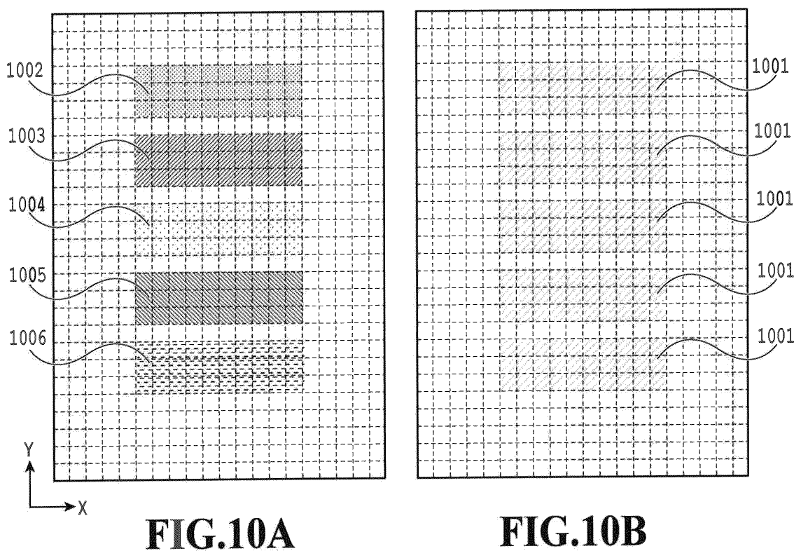

FIGS. 10A and 10B are diagrams showing an image for detecting the characteristic of the print element array 22 for the foaming promotion liquid. Like the submitted image (see FIGS. 4A and 4B), the image for characteristic detection is formed by a colored version, which is data for application of a colored liquid, and a foaming version, which is data for application of the foaming promotion liquid. In FIGS. 10A and 10B, the minimum-unit squares sectioned by broken lines each represent one pixel.

FIGS. 10A and 10B show an image for calculating a correction value for the application amount of the foaming promotion liquid, the image being printed on the printing medium 10 in S811 described earlier (see FIG. 8). The X-direction is a direction intersecting with the conveyance direction for the printing medium 10, and the plurality of print element arrays forming the printhead 21 are arrayed at positions different in the X-direction. The Y-direction is the direction in which the printing medium 10 is conveyed.

FIG. 10A shows, as an example of the foaming version, grayscale image data having 8-bit information for each color with the value of each pixel ranging from 0 to 255. However, the bit length for each color is not limited to 8 bits and may be 16 bits or the like. Unit regions 1002 to 1006 are regions used to analyze the characteristic of the print element array 22 and are where the foaming promotion liquid is applied. Specifically, the unit region 1002 is a region where the grayscale data has zero density and where the foaming promotion liquid is not applied. In comparison, the unit region 1003 is a region where the grayscale data has a density of m, the unit region 1004 is a region where the grayscale data has a density of n, the unit region 1005 is a region where the grayscale data has a density of o, and the unit region 1006 is a region where the grayscale data has a density of p. Because the density values are zero<m<n<o<p, the extent of expansion becomes larger and larger as follows: the unit region 1002<the unit region 1003<the unit region 1004<the unit region 1005<the unit region 1006.

FIG. 10B shows, as an example of the colored version, image data for three channels of R, G, and B. Although the image data has 8-bit information for each channel with the value ranging from 0 to 255 here, the number of bits is not limited thereto and may be 16 bits or the like. Unit regions 1001 are regions where a colored liquid is printed over the unit regions 1002 to 1006, and the cyan (C) ink is applied as the colored liquid to these regions in equal amounts. Note that the colored liquid may be the magenta (M) ink, the yellow (Y) ink, or the black (K) ink.

Although the foaming promotion liquid is printed in five shades (printed in the unit regions 1002 to 1006) in the mode described above, the number of shades may be any number. Specifically, the image for characteristic detection has at least N unit regions (where N is three or greater), and to these at least N unit regions, the colored liquid is applied in equal amounts and the foaming promotion liquid is applied in amounts varying in stages. The image for characteristic detection is printed on the printing medium 10, and the foaming layer is heated and expanded by the heater device 29. After that this printed image for characteristic detection is scanned by the scanner 30.

RGB data is obtained as a result of this scanning, and which of R-data, G-data, and B-data in the obtained RGB data to use to calculate a correction value for the application amount of the foaming promotion liquid is determined by which ink is applied as the colored liquid. To be more specific, in a case where the cyan (C) ink is applied, R-data, which is a complementary color of cyan (C), is used as scan values of the scanner 30 to calculate the correction value for the application amount of the foaming promotion liquid. In a case where the magenta (M) ink is applied as the colored ink, G-data, which is a complementary color of magenta (M), is used as scan values of the scanner 30. In a case where the yellow (Y) ink is applied as the colored ink, B-data, which is a complementary color of yellow (Y), is used as scan values of the scanner 30. In a case where the black (K) ink is applied as the colored ink, any of R-data, G-data, and B-data may be used as scan values of the scanner 30.

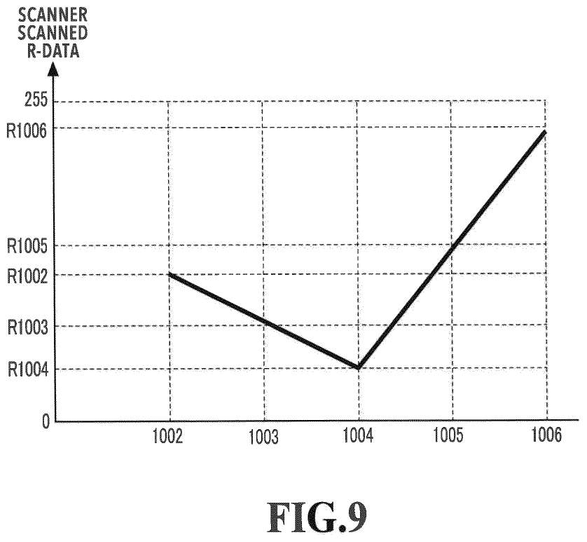

FIG. 9 shows R-data scan values obtained in the following conditions: the print element array 22 of the printhead 21 having ideal ejection characteristic prints an image for characteristic detection on the printing medium 10, and the scanner 30 scans the image for characteristic detection after the foaming layer 12 is heated and expanded by the heater device 29. The vertical axis represents R-data scan values, and the density increases toward 0 and decreases toward 255. The horizontal axis represents the unit regions 1002 to 1006. For both ideal values and actual measured values, the shape of a function indicating the correspondences between unit regions and scan values includes a region where a scan value increases and a region where a scan value decreases and has a second derivative (a second-order derivative) of 0 or greater (i.e., concave up), as shown in FIG. 9. Note that the shape of the function indicating the correspondences between unit region and scan values differs depending on the type of the scanner device, and in an example where the scanner device is a densitometer, the shape has a second derivative of 0 or below (i.e., concave down).

R1002 indicates an R-data scan value obtained by scanning of the unit region 1002 in FIG. 10A. Similarly, R1003 to R1006 are R-data scan values obtained by scanning of the unit regions 1003 to 1006, respectively. The inventors of the present application have found that the amount of foaming particles that foam changes depending on the amount of foaming promotion liquid applied to the foaming layer 12 and that an R-data scan value changes as the number of foaming particles that foam increases. The inventors of the present application have particularly found that, as shown in FIG. 9, as a result of varying the amount of foaming promotion liquid applied to the foaming layer 12, the density of R-data is higher in the unit region 1004 than in the unit region 1002 and is lower in the unit region 1006 than in the unit region 1004.

Increasing the application amount of foaming promotion liquid from the unit region 1002 to the unit region 1004 is thought to increase the density because it increases the extent of expansion of the foaming layer 12 and causes the colorant in the colored liquid that has permeated the lower part of the foaming layer 12 to migrate to the upper part of the foaming layer 12. Also, increasing the application amount of foaming promotion liquid from the unit region 1004 to the unit region 1006 is through to decrease the density because it increases the extent of expansion of the foaming layer 12 even more and increases the surface area of the foaming layer 12.

As described earlier, in the present embodiment, an image for characteristic detection is printed on the printing medium 10 and is then scanned by the scanner 30. Then, a correction value used to correct the application amount of the foaming promotion liquid is calculated based on the R-data scan values obtained and the ideal characteristics (i.e., the relation between the R-data and the application amount of the foaming promotion liquid) shown in FIG. 9 stored in the ROM 203 in advance. The following describes a mode where a correction factor is calculated as a specific example of the correction value.

A case is described as an example where a region from which the scanner 30 obtains the smallest R-data scan value (i.e., the highest density) is the unit region 1003, and a region with the highest density in the characteristic in FIG. 9 stored in the ROM 203 in advance is the unit region 1004. The correction factor is calculated based on the ratio of density values using Formula (1) below:

$$the correction factor = n \div m \qquad Formula ( 1 )$$

where m is the density value obtained from the unit region 1003, and n is the density value in the unit region 1004 shown in FIG. 9.

As another example, in a case where a region from which the scanner 30 obtains the smallest R-data scan value (i.e., the highest density) is the unit region 1005 and the characteristic in FIG. 9 is stored in the ROM 203 in advance, the correction factor is calculated using Formula (2) below:

$$the correction factor = n \div o \qquad Formula ( 2 )$$

In this way, the present embodiment calculates the correction factor as the correction value by dividing a predetermined density value n by the scanned density value of the unit region (e.g., m or o). The calculated correction factor is stored in the RAM 202, the ROM 203, or the like of the printing apparatus 20.

In regards to the ejection characteristic of the print element array 22 shown in FIG. 9, densities of R1002 to R1006 are lower in a case where the ink ejection characteristic (the ejection amount) of the print element array 24 is lower than ideal and are higher in a case where the ink ejection characteristic (the ejection amount) of the print element array 24 is higher than ideal. However, the fact that the density is highest at the scan value R1004 corresponding to the unit region 1004 does not change. Thus, although the cyan (C) ink and the foaming promotion liquid are applied in an overlapping manner in the method of the present embodiment, it is possible to detect the ejection characteristic of the print element array 22 and correct the application amount of the foaming promotion liquid without depending on the ink ejection characteristic of the print element array 24.

### <Flowchart of Processing Performed in Printing an Image>

FIG. 7 is a flowchart of processing performed in printing an image in the present embodiment. Specifically, the flowchart includes processing for correcting the application amount of the foaming promotion liquid using a correction value calculated for regions where the foaming promotion liquid (H) as well as the black (K) ink, the cyan (C) ink, the magenta (M) ink, and the yellow (Y) ink are applied. The present flowchart is implemented in the processing in S615 (see FIG. 6) described earlier, by the CPU 201 of the printing apparatus 20 reading and executing a program and data contained in the ROM 203 or the like. Note that the image processing accelerator 206 may be configured to execute part of the present flowchart.

In S701, the CPU 201 obtains a submitted image (see FIGS. 4A and 4B) included in a print job received in S614 (see FIG. 6). Here, the submitted image is obtained one page at a time.

In S702, the CPU 201 performs rendering processing on each of the foaming version and the colored version of the submitted image obtained in S701. The resolution of this rendering is one corresponding to the interval at which the print elements 31 shown in FIG. 3 are arrayed.

S703 to S704 are processing performed on the foaming version.

In S703, based on data represented by the foaming version, the CPU 201 generates print signal values for applying the foaming promotion liquid. A print signal value (H) for the foaming promotion liquid is 8-bit information defining the amount of foaming promotion liquid to be applied to each pixel, with the value ranging from 0 to 255. A value indicating the smallest application amount of the foaming promotion liquid is “0,” and a value indicating the largest application amount of foaming promotion liquid is “255.” For the conversion processing in S703, a known method may be used, such as matrix operation processing or processing using a one-dimensional lookup table. As a result of this conversion processing, a print signal value (H) for the foaming promotion liquid formed by one element is generated. Here, the following describes conversion processing that uses, as an example, a one-dimensional lookup table as data for conversion.

Formula (3) below shows a one-dimensional lookup table's function ID_LUT[Gray]:

$$H = 1 D\_LUT [ Gray ] \qquad Formula ( 3 )$$

where the variable Gray is the pixel value of each pixel in the foamed version.

The 1D_LUT above is formed by 256 data tables. To reduce the data volume of the lookup table, it is also possible to, for example, reduce the number of grids from 256 to 64 and calculate the result by interpolation computation using 64 data tables. The number of grids is not limited to 64 grids, and a favorable number of grids may be set appropriately, such as 32 or 16 grids. Also, any known method can be used for the interpolation computation, such as one-dimensional linear interpolation. In the present embodiment, a one-dimensional lookup table defined in advance is stored in the ROM 203 or the like of the printing apparatus 20.

In S704, the CPU 201 performs application amount correction on the print signal value (H) for the foaming promotion liquid generated in S703. A corrected print signal value (H′) for the foaming promotion liquid is generated based on the print signal value (H) for the foaming promotion liquid. The corrected print signal value (H′) for the foaming promotion liquid is, like the print signal value (H) for the foaming promotion liquid, 8-bit information defining the amount of foaming promotion liquid to be applied to each pixel, with the value ranging from 0 to 255. A value indicating the smallest application amount of foaming promotion liquid is “0,” and a value indicating the largest application amount of foaming promotion liquid is “255.” Formula 4 below shows a method of application amount correction processing where the print signal value (H) for the foaming promotion liquid is multiplied by a correction factor:

$${H}^{′} = H \times correction factor \qquad Formula ( 4 )$$

In the present embodiment, the correction value (specifically a correction factor) is calculated in S814 and is stored in the RAM 202, the ROM 203, or the like of the printing apparatus 20.

S705 to S706 are processing performed on the colored version.

In S705, the CPU 201 performs color correction processing based on data indicated by the colored version. Image data obtained by the color correction processing is RGB data, and at the end of this step, the data is in what is called a device RGB format specialized for the printing apparatus 20. A known method such as matrix operation processing or processing using a three-dimensional lookup table is used for the color correction processing and is converted to device color image data on a color signal formed by three elements. The following describes an example of color correction processing which uses a three-dimensional lookup table as a conversion table. Formulae (5) to (7) are the three-dimensional lookup table's function 3D_LUT[R][G][B][N]. R, G, and B values in the RGB data are inputted to variables R, G, and B. The variable N specifies one of R′, G′, and B′ outputted. Here, specifically, 0, 1, and 2 are specified as R′, G′, and B′, respectively.

$${R}^{′} = 3 D\_LUT [ R ] [ G ] [ B ] [ 0 ] \qquad Formula ( 5 )$$

$${G}^{′} = 3 D\_LUT [ R ] [ G ] [ B ] [ 1 ] \qquad Formula ( 6 )$$

$${B}^{′} = 3 D\_LUT [ R ] [ G ] [ B ] [ 2 ] \qquad Formula ( 7 )$$

The 3D_LUT above is formed by 256×256×256×3=50,331,648 data tables. To reduce the data volume of the lookup table, it is also possible to, for example, reduce the number of grids from 256 to 17 and calculate the result by interpolation computation using 14,739 (=17×17×17×3) data tables. The number of grids is not limited to 17 grids, and a favorable number of grids may be set appropriately, such as 16, 9, or 8 grids. Also, any known method can be used for the interpolation computation, such as tetrahedral interpolation. In the present embodiment, the three-dimensional lookup table defined in advance is stored in the ROM 203 or the like of the printing apparatus 20.

In S706, based on the R′, G′, and B′ data obtained by the color correction processing, the CPU 201 generates print signal values for application of the colored liquids using a three-dimensional lookup table. A print signal value (C) defines the amount of cyan (C) ink applied to each pixel. Similarly, a print signal value (M) defines the application amount of magenta (M) ink; a print signal value (Y), the yellow (Y) ink; and a print signal value (K), the black (K) ink. The print signal value for each color is 8-bit information with the value ranging from 0 to 255. A value indicating the smallest application amount of colored liquid is “0,” and a value indicating the largest application amount of colored liquid is “255.” In the present embodiment, a three-dimensional lookup table is used to perform conversion processing to obtain the print signal values of the colored liquids as shown below. Formulae (8) to (11) below are the three-dimensional lookup table's function 3D_LUT[R′][G′][B′](N]. R′, G′, and B′ values in the R′G′B′ data are inputted to variables R′, G′, and B′. The variable N specifies one of C, M, Y, and K outputted. Here, specifically, 0, 1, 2, and 3 are specified as C, M, Y, and K, respectively.

$$C = 3 D\_LUT [ R ] [ G ] [ B ] [ 0 ] \qquad Formula ( 8 )$$

$$M = 3 D\_LUT [ R ] [ G ] [ B ] [ 1 ] \qquad Formula ( 9 )$$

$$Y = 3 D\_LUT [ R ] [ G ] [ B ] [ 2 ] \qquad Formula ( 10 )$$

$$K = 3 D\_LUT [ R ] [ G ] [ B ] [ 3 ] \qquad Formula ( 11 )$$

In the present embodiment, the three-dimensional lookup table defined in advance is stored in the ROM 203 or the like of the printing apparatus 20.

In S707, the CPU 201 performs quantization processing based on the corrected print signal value (H′) for the foaming promotion liquid as well as the print signal value (K), the print signal value (C), the print signal value (M), and the print signal value (Y) for the colored liquids. Various quantization levels can be used for the quantization processing in this step, such as two-level, three-level, or 16-level quantization. Typically, for the two-level quantization, the corrected print signal value (H′) for the foaming promotion liquid is converted into 1-bit data for the foaming promotion liquid (h). Similarly, the print signal value (K), the print signal value (C), the print signal value (M), and the print signal value (Y) are converted to 1-bit data for black (k), cyan (c), magenta (m), and yellow (y), respectively. This 1-bit data indicates whether to apply a liquid droplet of the foaming promotion liquid or the colored liquid, i.e., whether to form a dot of the foaming promotion liquid or the colored liquid on the printing medium 10. For the quantization process in this step, pseudo-midtone processing such as the known dithering matrix method and error diffusion method is used.

In S708, the CPU 201 executes control processing for the printhead 21. Specifically, the quantized data is transferred to the head controller 205. After that, based on the quantized data, the foaming promotion liquid and the colored liquids are ejected from the print elements 31 and applied to the printing medium 10. After the foaming promotion liquid and the colored liquids are applied to the printing medium 10 to print an image, the quantized data is stored in the RAM 202 for a certain period of time.

In S709, the CPU 201 determines whether image printing has been printed on all the pages to be printed. If the result of the determination of this step is true, the series of steps shown in FIG. 7 is ended, and the processing proceeds to S615 in FIG. 6. If the result of the determination of this step is false, the processing proceeds back to S701 to continue the processing for the next page.

As thus described using FIGS. 7 to 10B, the present embodiment can achieve an ideal expansion height by calculating a correction value for the application amount of the foaming promotion liquid, i.e., for the print signal value (H), and correcting the application amount using the calculated correction value. Although the application amount correction in the present embodiment calculates the correction factor using formulae, it is to be noted that a method may be employed in which the application amount is derived using a 1D_LUT.

### Modification of the Present Embodiment

The embodiment above has described a mode where a correction factor is calculated using Formula (1) in a case where the density is the highest in the unit region 1004. In contrast to this, in the present modification, a correction factor is calculated based on the slope between R1002 as the scanner scanned R-data in FIG. 9 and R-data in the region where the density of the R-data scan value obtained by the scanner 30 is the highest (one of R1003 to R1006).

As an example, in a case where the unit region 1005 is the region with the highest density in terms of the R-data scan value obtained by the scanner 30, it means that the ejection characteristic of the print element array 22 is lower than ideal. Thus, the slope between R1002 and R1005 is gentler than the ideal value (with a large slope value). Then, a correction value is calculated using Formula (12) below:

$$correction factor = a \div b \qquad Formula ( 12 )$$

where a is the slope value corresponding to the ideal characteristic shown in FIG. 9 stored in the ROM 203 in advance, and b is the slope value of the slope between R1002 and R1005.

Further, in a case where the unit region 1003 is the region with the highest density in terms of the R-data scan value obtained by the scanner 30, it means that the ejection characteristic of the print element array 22 of the printhead 21 is higher than ideal. Thus, the slope between R1002 and R1003 is steep (with a small slant value), and in this case, a correction value is calculated using Formula (13) below:

$$correction factor = a \div c \qquad Formula ( 13 )$$

where c is the slope value of the slope between R1002 and R1003.

In this way, in the present modification, the slope of a density scanned by the scanner changes depending on the ejection characteristic of the print element array 22 that ejects the foaming promotion liquid (H). According to the method of the present modification, although the cyan (C) ink and the foaming promotion liquid (H) are applied in an overlapping manner, the ejection characteristic of the print element array 22 can be detected to correct the application amount of the foaming promotion liquid without depending on the ejection characteristic of the print element array 24 that ejects the cyan (C) ink.

### Advantageous Effects of the Present Embodiment Etc.

The present embodiment has thus described a case of using a region with the highest density and a case of using the slope of a change in the application amount of the foaming promotion liquid. Any method can be used as long as it calculates a correction value for the application amount of the foaming promotion liquid by utilizing the phenomenon where an image for detecting the characteristic of the print element array printed by application of a colored liquid and the foaming promotion liquid increases and then decreases in density due to expansion of the foaming layer 12, as shown in FIG. 9.

### Second Embodiment

The first embodiment has described a case where the same correction value is applied to all the print elements 31 of the print element array 22. The present embodiment describes a case where the correction value is not the same for each of the print elements 31 of the print element array 22.

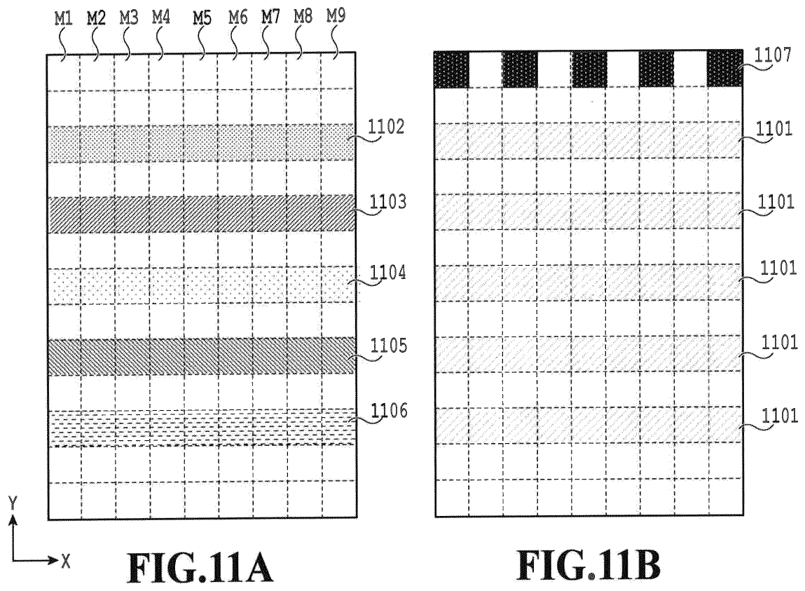

FIGS. 11A and 11B are diagrams showing an image for characteristic detection used to calculate a correction value for the application amount of each of the print elements 31 of the print element array 22. Unit regions 1101 to 1106 shown in FIGS. 11A and 11B are the same as those described in the first embodiment to simplify description (see the description related to FIGS. 10A and 10B), except that the foaming promotion liquid is applied to the unit regions 1102 to 1106 over the entire area of the printing medium 10 in the X-direction to calculate correction values for the individual print elements 31.

Marks 1107 are marks for identifying the positions of the print elements 31. Because the print element array 22 and the print element array 24 are aligned in position using a known method, the print elements 31 of the print element array 22 and the print elements 31 of the print element array 24 coincide in terms of print position. Thus, application of the cyan (C) ink makes it possible to identify the positions of the print elements 31 in the print element array 22 that ejects the foaming promotion liquid (H). In the overlap region D, the print elements 31 in one of the print element substrates 32 are used. In each of FIGS. 11A and 11B, the minimum-unit squares sectioned by the broken lines each represent a region where the foaming promotion liquid is applied from one print element 31 in the print element array 22, and nine print elements 31 corresponding to regions M1 to M9 print an image on the printing medium 10. Note that the number of regions are not limited to nine as long as there are at least M regions where M is two or greater.

Then, based on R-data scan values obtained by the scanner 30 from the unit regions 1102 to 1106 at the X-direction position of the region M1, the density value of the region having the highest density is calculated. Similarly, the density value of the region with the highest density is calculated for each of the X-direction positions of the regions M2 to M9. Next, the average value is calculated of the density values calculated for each of the X-direction positions of the regions M1 to M9. Next, a correction value is calculated based on the average density value and the density value of the region with the highest density at the X-direction position of each of the regions M1 to M9. Specifically, as an example, in a case where the density is highest in the unit region 1103 at the X-direction position of the region M1, the correction factor (M1) is calculated using Formula (14) below:

$$correction factor M 1 = average density value 7 \div m \qquad Formula ( 14 )$$

where m is the density value of the unit region 1103.

Similarly, correction factors M2 to M9 for the regions M2 to M9 are calculated. In the present embodiment, the correction factors M1 to M9 thus calculated are stored in the RAM 202, the ROM 203, or the like of the printing apparatus 20.

The correction factors M1 to M9 for the respective X-direction positions of the regions M1 to M9 may be calculated using, like in the first embodiment, the density value n of the unit region 1004 for the ideal ink ejection characteristic of the print element array 22 shown in FIG. 9 stored in the ROM 203 in advance.

In image processing with the thus-calculated correction of the application amount of the foaming promotion liquid, a submitted image is divided into nine parts in S704 (see FIG. 7), and a correction factor is applied to the print element 31 corresponding to each of the divided regions.

Although a correction factor is calculated for each of the print elements 31 in the embodiment described above, a method may be employed where a correction factor is calculated for a plurality of print elements 31.

In this way, the present embodiment corrects the application amount of the foaming promotion liquid by applying a correction value to each of the print elements 31. This advantageously helps achieve a uniform foam height on the printing medium 10.

### Third Embodiment

The first and second embodiments have described cases where the application amount is not corrected for the print element array 24 for the colored liquid in formation of the image for detecting the characteristic of the print element array 22 for the foaming promotion liquid on the printing medium 10. The present embodiment describes a case where the application amount of the colored liquid from the print element array 24 is corrected in prior to the formation of the image for detecting the characteristic of the print element array 22 for the foaming promotion liquid on the printing medium 10.

A known calibration method can be used for the correction of the application amount of the colored liquid from the print element array 24. Specifically, only the colored liquid is applied to the printing medium 10 in a plurality of density values, e.g., a density value e, a density value f, a density value g, and a density value h (c<f<g<h) and is scanned by the scanner 30. Further, the scan values of the density values e to h are compared to a scan value T for the ideal ink ejection characteristic of the print element array 24 for the colored liquid, which is stored in the ROM 203 in advance, to find a density value substantially the same as T. Next, based on the density value thus calculated, a correction factor for the application amount of the colored liquid is calculated. Next, like in the first embodiment, in the formation of the image for detecting the characteristic of the print element array 22 for the foaming promotion liquid on the printing medium 10 as shown in FIGS. 10A and 10B, the colored liquid from the print element array 24 is applied in the corrected amount. The image for characteristic detection thus printed is then scanned by the scanner 30. This idealizes the ink ejection characteristic of the print element array 24, so that R-data scan values obtained have variance only in the ejection characteristic of the print element array 22. The correction factor for the application amount of the foaming promotion liquid is calculated based on the R-data scan values obtained by the scanner 30, and the method for this calculation is the same as that in the first embodiment.

In the case in the second embodiment where the correction factor for the application amount of the foaming promotion liquid is calculated for each of the print elements 31, the image for characteristic detection is printed with the application amount for each of the print elements 31 in the print element array 24 being corrected in advance. After that, a correction factor for the application amount is calculated for each of the print elements 31 in the print element array 22 for the foaming promotion liquid.

In this way, the present embodiment applies the colored liquid in a corrected application amount in the formation of the image for detecting the characteristic of the print element array 22 on the printing medium 10. This advantageously can calculate a correction value for the application amount of the foaming promotion liquid, like in the embodiments described above.

### OTHER EMBODIMENTS

Although the embodiments above describe cases where an inkjet printhead is used to apply the foaming promotion liquid, a means used to apply the foaming promotion component is not limited to an inkjet printhead. The foaming promotion liquid may be applied to a printing medium using a roller or the like or may be applied using other application methods such as one using electrophotography. Also, a method for forming the textured structure is not limited to application of the foaming promotion liquid to a printing medium containing foaming particles, but may be application of foaming particles to a printing medium.

Also, although the embodiments above describe cases where foaming particles are foamed by heat, a means used to foam the foaming particles is not limited to heating. The method and means of foaming are not limited to heat energy, and the technique of the present disclosure can be applied as long as foaming occurs upon exertion of any type of energy, such as application of light having a particular wavelength.

Also, although the embodiments above describe cases where the foaming promotion liquid has a function to lower the temperature at which foaming particles start foaming, the function of the foaming promotion liquid is not limited to this. The foaming promotion liquid may have a function such that application of the foaming promotion liquid makes it easier for the foaming particles to foam or increases the number of foaming particles that actually foam, with the same energy being exerted.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present disclosure can detect the ejection characteristic of print elements for the foaming promotion liquid.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-162507, filed Sep. 19, 2024, which is hereby incorporated by reference herein in its entirety.

What is claimed is:

1. A printing apparatus comprising:
a printhead configured to print an image for characteristic detection onto a printing medium containing foaming particles by ejecting a foaming promotion liquid and a colored liquid to the printing medium, the image for characteristic detection having at least N unit regions (where N is three or greater), the colored liquid being applied to the at least N unit regions in equal amounts, and the foaming promotion liquid being applied to the at least N unit regions in amounts varying in stages;
a foaming unit configured to foam the foaming particles contained in the printing medium after the image for characteristic detection is printed by the printhead;
a scan unit configured to scan the image for characteristic detection after the foaming particles are foamed by the foaming unit, the scan unit obtaining, as scan results of the image for characteristic detection, correspondences between the at least N unit regions and scan values of the colored liquid in the respective at least N unit regions, the correspondences including a region where a scan value obtained by the scan unit increases and a region where a scan value obtained by the scan unit decreases; and
a calculation unit configured to calculate a correction value for correcting an application amount of the foaming promotion liquid based on the scan results, the calculation unit being configured to calculate the correction value based on a first density value corresponding to a first unit region of the at least N unit regions which is where the scan unit obtains a lowest scan value.

2. The printing apparatus according to claim 1, wherein
a shape of a function indicating the correspondences is different depending on a type of the scan unit and is concave up in a case where a second derivative is 0 or greater or is concave down in a case where a second derivative is 0 or smaller.

3. The printing apparatus according to claim 2, wherein
the printhead has a first print element array configured to eject the foaming promotion liquid and a second print element array configured to eject the colored liquid, and
the correction value is a value for correcting the application amount of the foaming promotion liquid ejected from the first print element array.

4. The printing apparatus according to claim 3, further comprising a storage unit, wherein
the calculation unit calculates the correction value based on the first density value and a predetermined density value stored in the storage unit in advance.

5. The printing apparatus according to claim 4, wherein
the calculation unit calculates a correction factor as the correction value by dividing the predetermined density value by the first density value.

6. The printing apparatus according to claim 5, wherein
the calculation unit calculates the correction value based on a slope value calculated using a difference between the first density value corresponding to the first unit region and a second density value corresponding to a second unit region among the at least N unit regions which is where the foaming promotion liquid is not applied and an application amount of the foaming promotion liquid corresponding to the first unit region.

7. The printing apparatus according to claim 6, further comprising a storage unit, wherein
the calculation unit calculates the correction value based on the slope value and an ideal slope value stored in the storage unit in advance.

8. The printing apparatus according to claim 7, wherein
the calculation unit calculates a correction factor as the correction value by dividing the ideal slope value by the slope value.

9. The printing apparatus according to claim 3, wherein
for each of print element regions printed by M print elements (where M is two or greater) of the first print element array, the calculation unit calculates a lowest density value among density values of the at least N unit regions in terms of the scan values obtained by the scan unit, calculates an average value of the density values calculated for each of the print element regions printed by the M print elements, and calculates the correction value using the calculated average value.

10. The printing apparatus according to claim 9, wherein
the calculation unit calculates a correction factor as the correction value, and
the correction factor is a value obtained by dividing the average value by the lowest density value calculated for each of the print element regions printed by the M print elements.

11. The printing apparatus according to claim 3, wherein
before the printhead prints the image for characteristic detection, an application amount of the colored liquid from the second print element array is corrected in advance.

12. The printing apparatus according to claim 1, wherein
the foaming promotion liquid contains a foaming promotion component that causes the foaming particles contained in the printing medium to foam under heat,
the foaming promotion component lowers a temperature at which the foaming particles start foaming, and
the colored liquid contains a colorant.

13. The printing apparatus according to claim 1, further comprising a conveyance unit configured to convey the printing medium, wherein
a print operation by the printhead and a conveyance operation by the conveyance unit are performed alternately.

14. The printing apparatus according to claim 1, wherein
the foaming unit is a heating device having a heating unit.

15. A method for controlling a printing apparatus including
a printhead configured to print an image for characteristic detection onto a printing medium containing foaming particles by ejecting a foaming promotion liquid and a colored liquid to the printing medium, the image for characteristic detection having at least N unit regions (where N is three or greater), the colored liquid being applied to the at least N unit regions in equal amounts, and the foaming promotion liquid being applied to the at least N unit regions in amounts varying in stages,
a foaming unit configured to foam the foaming particles contained in the printing medium after the image for characteristic detection is printed by the printhead, and
a scan unit configured to scan the image for characteristic detection after the foaming particles are foamed by the foaming unit, the scan unit obtaining, as scan results of the image for characteristic detection, correspondences between the at least N unit regions and scan values of the colored liquid in the respective at least N unit regions, the correspondences including a region where a scan value obtained by the scan unit increases and a region where a scan value obtained by the scan unit decreases,
the method comprising calculating a correction value for correcting an application amount of the foaming promotion liquid based on the scan results, the calculating including calculating the correction value based on a first density value corresponding to a first unit region of the at least N unit regions which is where the scan unit obtains a lowest scan value.

16. A non-transitory computer readable storage medium storing a program for causing a computer to execute a method for controlling a printing apparatus including
a printhead configured to print an image for characteristic detection onto a printing medium containing foaming particles by ejecting a foaming promotion liquid and a colored liquid to the printing medium, the image for characteristic detection having at least N unit regions (where N is three or greater), the colored liquid being applied to the at least N unit regions in equal amounts, and the foaming promotion liquid being applied to the at least N unit regions in amounts varying in stages,
a foaming unit configured to foam the foaming particles contained in the printing medium after the image for characteristic detection is printed by the printhead, and
a scan unit configured to scan the image for characteristic detection after the foaming particles are foamed by the foaming unit, the scan unit obtaining, as scan results of the image for characteristic detection, correspondences between the at least N unit regions and scan values of the colored liquid in the respective at least N unit regions, the correspondences including a region where a scan value obtained by the scan unit increases and a region where a scan value obtained by the scan unit decreases,
the method comprising calculating a correction value for correcting an application amount of the foaming promotion liquid based on the scan results, the calculating including calculating the correction value based on a first density value corresponding to a first unit region of the at least N unit regions which is where the scan unit obtains a lowest scan value.
